(19) United States
(12) Patent Application Publication
(10) Pub. No.: US 2026/0121190 A1
(43) Pub. Date: Apr. 30, 2026

(54) ELECTRICITY STORAGE DEVICE AND ELECTRICITY STORAGE MODULE

(71) Applicant: Prime Planet Energy & Solutions, Inc., Tokyo (JP)

(72) Inventor: Yoshihiko SATO, Asago-shi (JP)

(21) Appl. No.: 19/363,649

(22) Filed: Oct. 21, 2025

(30) Foreign Application Priority Data
Oct. 29, 2024 (JP) 2024-189834

(51) Int. Cl. H01M 50/242; H01M 10/0587; H01M 50/103

(52) U.S. Cl. CPC H01M 50/242; H01M 10/0587; H01M 50/103

(57) ABSTRACT

It is to provide an electricity storage device in which a strength of an outer case is enhanced. The electricity storage device disclosed herein includes an electrode assembly including a positive electrode and a negative electrode, and includes an outer case that is configured to accommodate the electrode assembly and that is made of a metal. On the outer case, a fiber is continuously wound to cover an outer periphery side surface, so as to be aligned along a predetermined direction.

### CROSS REFERENCE TO RELATED APPLICATIONS

The present application claims the benefit of priority to Japanese Patent Application No. 2024-189834 filed on Oct. 29, 2024. The entire contents of this application are hereby incorporated herein by reference.

### BACKGROUND

### Technical Field

A present disclosure relates to an electricity storage device and an electricity storage module that contains this electricity storage device.

Background Art International publication WO2018/168549 discloses an all-solid state secondary battery that includes a cylindrical battery element member including a current collector, a solid electrolyte layer, and a positive electrode active material layer, includes an axis core whose a side surface with which this battery element member is provide on an outer periphery, and includes a battery outer case configured to accommodate this battery element member and this axis core. On the side surface outer periphery of the battery outer case of the all-solid state secondary battery described above, a reinforced covering body is provided. This reinforced covering body is arranged to have a compressive stress being equal to or more than 0.5 MPa between the axis core and the battery element member and between the battery outer case and the battery element member so as to press the battery outer case toward an inner side. By doing this, it is made to be able to suppress an expansion of the battery outer case.

In addition, Japanese Patent Application Publication No. 2020-155356 discloses a manufacturing method of a case, in which a resin-impregnated carbon fiber is made to follow and be wound about a mold for the case (a mandrel). The case manufactured by the manufacturing method described above is made from fiber reinforced plastic and has an elasticity. A narrow width surface of the case described above is a contact part that comes into contact with an electrode assembly having a laminate structure. In addition, a wide width surface of the case has a spring structure configured to connect this contact part.

### SUMMARY

An electricity storage device, such as lithium ion secondary battery, swells according to an electrical charge and discharge. The present inventor thinks to suppress the swell of the above described electricity storage device.

### Solution to Problem

A herein disclosed electricity storage device includes an electrode assembly including a positive electrode and a negative electrode, and includes an outer case that is made of metal and that accommodates the electrode assembly. On this outer case, a continuous fiber is wound to cover an outer periphery side surface, while the fiber is to be aligned along a predetermined direction.

According to the electricity storage device described above, it is possible to suppress the swell of the electricity storage device. Furthermore, it is possible to enhance a strength of the outer case.

### BRIEF DESCRIPTION OF DRAWINGS

FIG. 1 is a perspective view that schematically shows a lithium ion secondary battery.

FIG. 2 is a schematic perspective view in which a lithium ion secondary battery is viewed from a direction that is different from FIG. 1.

FIG. 3 is a longitudinal cross section view that schematically shows the lithium ion secondary battery.

FIG. 4 is an exploded view of an electrode assembly (a wound electrode assembly).

FIG. 5 is a schematic view that is for explaining a state after a swell of an electricity storage device.

FIG. 6 is an enlarged cross section view that is schematically shown to explain the state after the swell of the electricity storage device.

FIG. 7 is a schematic plane view in which the lithium ion secondary battery is viewed from a narrow width surface side.

FIG. 8 is a schematic plane view in which the lithium ion secondary battery is viewed from a wide width surface side.

FIG. 9 is an explanation view that is to illustrate how to wind a fiber onto the lithium ion secondary battery.

FIG. 10 is a perspective view that schematically shows an electricity storage module containing the herein disclosed electricity storage device.

FIG. 11 is a perspective view that schematically shows a pack case type electricity storage module containing the herein disclosed electricity storage device.

### DESCRIPTION OF EMBODIMENTS

Below, an electricity storage device of the present disclosure would be described in detail. Incidentally, in drawings, the members/parts providing the same effect are provided with the same numerals and signs and are explained. Further, the dimensional relation (such as length, width, and thickness) in each drawing does not always reflect the actual dimensional relation. Reference signs L, R, U, D, F, and Rr in the drawings respectively represent left, right, up, down, front, and rear of the lithium ion secondary battery 1. In addition, a left and right direction is defined as X, an up and down direction is defined as Y, and a front and rear direction is defined as Z. However, these are merely directions for convenience sake of explanation, and are not to restrict a disposed aspect of the electricity storage device (the lithium ion secondary battery 1).

### Definition of Term

In the present description, a wording “electricity storage device” is a concept that semantically covers a device generating an electrical charge and discharge response by a movement of a charge carrier between a pair of electrodes (a positive electrode and a negative electrode). In other words, the electricity storage device semantically covers a battery, such as secondary battery (for example, a lithium ion secondary battery, a nickel hydrogen battery, and a nickel cadmium battery), and a capacitor (a physical battery), such as lithium ion capacitor and electric double layer capacitor. Incidentally, below, while the lithium ion secondary battery being a typical one of the electricity storage device is used as an example, this embodiment will be described. In addition, the wording “lithium ion secondary battery” in the present description represents an electricity storage device which uses a lithium ion as a charge carrier and in which the electrical charge and discharge is repeatedly implemented due to a movement of the electrical charge according to the lithium ion between the positive electrode and the negative electrode.

When a numerical value range is described as “A to B (here, A and B are arbitrary values)” in the present description, it means “equal to or more than A and not more than B” and it semantically covers meanings “more than A and less than B”, “more than A and not more than B”and “equal to or more than A and less than B”.

### Electricity Storage Device: Lithium Ion Secondary Battery 1

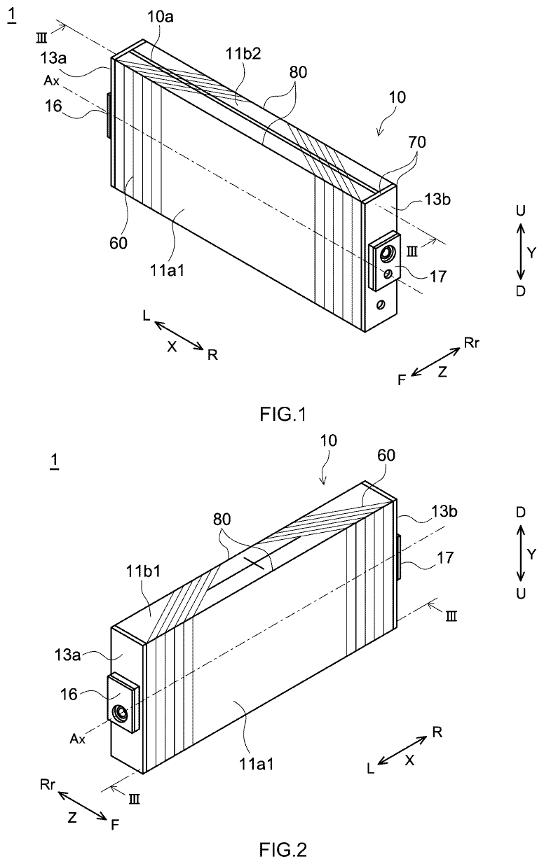

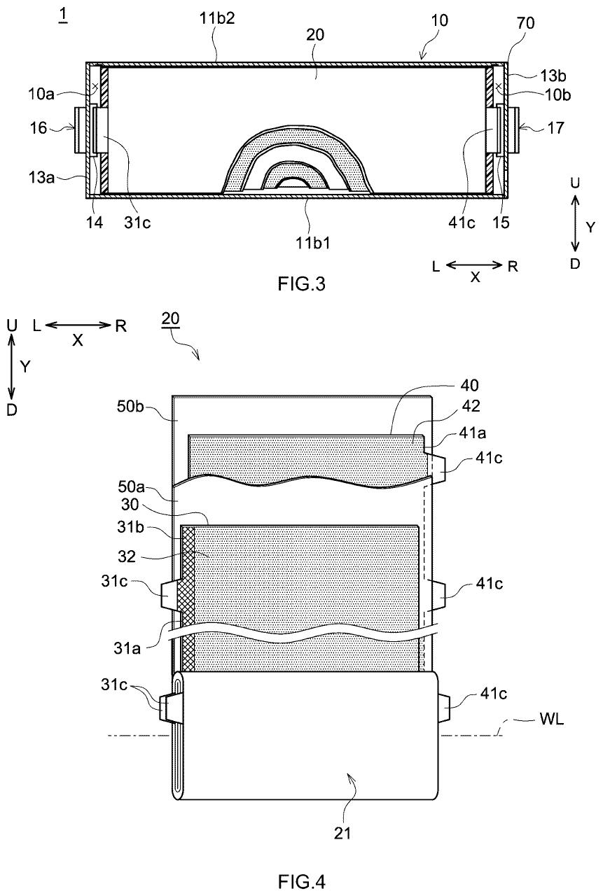

FIG. 1 is a perspective view that schematically shows the lithium ion secondary battery 1. FIG. 2 is a schematic perspective view in which the lithium ion secondary battery 1 is viewed from a direction that is different from FIG. 1. In FIG. 1 and FIG. 2, for clearly showing a configuration of an outer case 10, a fiber 60 is partially removed and shown. FIG. 3 is a longitudinal cross section view that schematically shows the lithium ion secondary battery 1. In FIG. 3, the longitudinal cross section view being along a III-III line of FIG. 1 is shown. In FIG. 3, for clearly showing a configuration of an electrode assembly 20 accommodated in the outer case 10, a part of the electrode assembly 20 is transparently shown. FIG. 4 is an exploded view of an electrode assembly 20 (a wound electrode assembly).

The lithium ion secondary battery 1 shown in FIG. 1 to FIG. 3 is a suitable example of the herein disclosed electricity storage device. The lithium ion secondary battery 1, as shown in FIG. 1 to FIG. 3, includes the electrode assembly 20 and the outer case 10.

### Electrode Assembly 20

As shown in FIG. 3 and FIG. 4, the electrode assembly 20 includes a positive electrode 30 and a negative electrode 40. In this embodiment, the electrode assembly 20 is a wound electrode assembly, in which the positive electrode 30 formed in a strip-like shape and the negative electrode 40 formed in a strip-like shape are stacked via separators 50a, 50b formed in strip-like shapes along a length direction, and which is then wound around a winding axis WL set in a width direction of the positive electrode 30. In this embodiment, the electrode assembly 20 includes a positive electrode tab 31c that is provided at one end in the winding axis direction. In addition, at the other end in the winding axis direction, a negative electrode tab 41c is provided. In other words, regarding this embodiment, the positive electrode tab 31c is provided at one of end parts of the electrode assembly 20 and the negative electrode tab 41c is provided at the other one of end parts, along the winding axis. Incidentally, the electrode assembly 20 is not restricted to the wound electrode assembly, and might be a laminate type electrode assembly in which the positive electrode and the negative electrode are alternately stacked via the separators. In addition, the laminate type electrode assembly might be formed to have a so-called tsuzuraori shape in which the Z-shaped separators sandwich the positive electrode and the negative electrode between the separators and then folded and bent in a zig-zag shape.

### Positive Electrode 30

As shown in FIG. 4, the positive electrode 30 includes a positive electrode current collector foil 31 that is formed in a rectangular shape, and a positive electrode active material layer 32 that is formed on a surface of this positive electrode current collector foil 31. The positive electrode active material layer 32 can reversibly store and release the charge carrier (for example, the lithium ion). In other words, the positive electrode active material layer 32 contains a positive electrode active material that can release the charge carrier at an electrically charging time and can store the charge carrier at an electrically discharging time. Incidentally, it is good if the positive electrode active material layer 32 is formed on one surface or both surfaces (here, both surfaces) of the positive electrode current collector foil 31. In addition, the positive electrode 30 might include a positive electrode active material layer non-formation part 31a on which the positive electrode active material layer 32 is not formed and thus the positive electrode current collector foil 31 is exposed. The positive electrode active material layer non-formation part 31a is provided at one end of the electrode assembly 20. In this embodiment, at a border of the positive electrode active material layer 32, a positive electrode protective layer 31b is provided on the positive electrode current collector foil 31 (further particularly, the positive electrode active material layer non-formation part 31a). The positive electrode protective layer 31b is a layer configured to protect the positive electrode active material layer non-formation part 31a, and is a layer containing an inorganic filler (for example, alumina, or the like).

As a material of the positive electrode current collector foil 31, it is possible to use a well known positive electrode current collector foil that is used on this kind of electricity storage device, and that is not particularly restricted. As the material of the positive electrode current collector foil 31, for example, it is possible to use an aluminum or an aluminum alloy. As the positive electrode active material of the positive electrode active material layer 32, it is possible to use a positive electrode active material used for the positive electrode of a general lithium ion secondary battery. As the lithium composite metal oxide, it is possible to use LiCoO₂, LiNiO₂, LiFeO₂, LiNiₓCo_{y}Mn_{1-x-y}O₂ (NCM), LiNi_{0.5}Mn1.5O₄, LiNi_{0.8}Co_{0.15}Al0.05O₂ (NCA), LiCrMO₄, LiMn₂O₄, LiFePO₄ (LFP), or the like. Incidentally, regarding these positive electrode active materials, 1 kind might be used alone, or 2 or more kinds might be combined and then used. Incidentally, the positive electrode active material layer 32 might contain various additives, such as binding agent (binder), conductive assistant agent, inorganic filler, and thickening agent.

### Negative Electrode 40

As shown in FIG. 4, the negative electrode 40 includes a negative electrode current collector foil 41 that is formed in a rectangular shape and a negative electrode active material layer 42 that is formed on a surface of the negative electrode current collector foil 41. The negative electrode active material layer 42 can reversibly store and release the charge carrier (for example, the lithium ion). In other words, the negative electrode active material layer 42 contains a negative electrode active material that can store the charge carrier at the electrically charging time and can release the charge carrier at the electrically discharging time. Incidentally, it is good if the negative electrode active material layer 42 is formed on one surface or both surfaces (here, both surfaces) of the negative electrode current collector foil 41. In addition, the negative electrode 40 might include a negative electrode active material layer non-formation part 41a on which the negative electrode active material layer 42 is not formed and thus the negative electrode current collector foil 41 is exposed. The negative electrode active material layer non-formation part 41a is provided at one end of the electrode assembly 20.

As a material of the negative electrode current collector foil 41, it is possible to use a well known negative electrode current collector foil that is used on this kind of electricity storage device, and that is not particularly restricted. As the material of the negative electrode current collector foil 41, for example, it is possible to use a copper or a copper alloy. As the negative electrode active material of the negative electrode active material layer 42, it is possible to use a negative electrode active material used for the negative electrode of a general lithium ion secondary battery. In particular, as the negative electrode active material, it is possible to use a carbon material, such as soft carbon (easily graphitized carbon), amorphous carbon material, graphite, hard carbon (hardly graphitized carbon), and carbon nanotube, a silicon chemical compound, or the like. Incidentally, regarding these negative electrode active materials, 1 kind might be used alone, or 2 or more kinds might be combined and then used. Incidentally, the negative electrode active material layer 42 might contain the various additives, such as binding agent (binder), conductive assistant agent, inorganic filler, and thickening agent.

### Separator 50a, 50b

The separators 50a, 50b of this embodiment are porous sheets that have insulating properties. However, it is good that a shape or a size of the separator 50a, 50b is suitably decided in accordance with a design of the electricity storage device, and thus is not particularly restricted. Typically, since the separators 50a, 50b are used for establishing an insulation between the positive electrode 30 and the negative electrode 40, the sizes of the separators 50a, 50b are larger than the positive electrode 30 and the negative electrode 40. As a material of the separators 50a, 50b, it is possible to use a well known material that is used for this kind of electricity storage device, and it is not particularly restricted. For example, as the material of the separators 50a, 50b, it is possible to suitably use a polyolefin, such as polyethylene and polypropylene, and a resin, such as polyester, cellulose, and polyamide.

### Outer Case 10

The outer case 10 is a metal case in which the electrode assembly 20 is accommodated. In this embodiment, the outer case 10 is formed in a hexahedron shape (in other words, a polygonal shape) that can accommodate the electrode assembly 20. In this embodiment, the electrode assembly 20 is accommodated in the outer case 10 so as to have a laminate structure in which the strip-like shaped positive electrode 30 and the strip-like shaped negative electrode 40 are stacked via the separators 50a, 50b along a pair of opposed wide width surfaces 11a1, 11a2 of the polygonal case. The outer case 10 is configured with a body 11 and two sealing plates 13a, 13b. Additionally, in this embodiment, the positive electrode outside terminal 14 and the negative electrode outside terminal 15 are respectively provided on two sealing plates 13a, 13b.

The body 11 is a member formed in a so-called square tube shape. The body 11 includes the pair of opposed wide width surfaces 11a1, 11a2 around a left and right direction X and a pair of opposed narrow width surfaces 11b1, 11b2. The pair of opposed narrow width surfaces 11b1, 11b2 and the pair of opposed wide width surfaces 11a1, 11a2 are respectively continued at long sides. The body 11 includes opening parts 10a, 10b (see FIG. 3) at both sides along the left and right direction X. Incidentally, in an explanation described below, for convenience sake, one wide width surface 11a1 among the pair of opposed wide width surfaces 11a1, 11a2 might be also referred to as “first surface” and the other wide width surface 11a2 might be also referred to as “second surface”. In addition, among the pair of opposed narrow width surfaces 11b1, 11b2, one narrow width surface 11b1 might be also referred to as “bottom surface”, and the other narrow width surface 11b2 might be also referred to as “upper surface”.

A thickness of the body 11 (a plate thickness), in other words, a mean plate thickness of each of the wide width surfaces 11a1, 11a2 and the narrow width surfaces 11b1, 11b2 is not particularly restricted. Typically, an upper limit value of the thickness of the body 11 (the plate thickness) might be equal to or less than 3 mm, equal to or less than 2 mm, or equal to or less than 1 mm. A lower limit value of the thickness of the body 11 (the plate thickness) might be equal to or more than 0.3 mm, equal to or more than 0.4 mm, or equal to or more than 0.5 mm.

In this embodiment, the body 11 can be manufactured, for example, by folding and bending one metal plate to mold into a cylindrical shape, and then by joining (for example, welding, adhering, or the like) a seam. Additionally, in this embodiment, a welded and joined part 10c (a wavy line of FIG. 1) is formed along the left and right direction X on the upper surface 11b2.

The sealing plates 13a, 13b are plate-shaped members configured to cover the pair of opening parts 10a, 10b of the body 11. In this embodiment, the sealing plates 13a, 13b are arranged at side peripheral edges of the pair of opening parts 10a, 10b, and are configured with rectangular members covering the pair of opening parts 10a, 10b of the body 11. In this embodiment, at one sealing plate 13a, the positive electrode outside terminal 14 is attached while being in an insulated state. At the other sealing plate 13b, the negative electrode outside terminal 15 is attached while being in an insulated state. Incidentally, in an explanation described below, for convenience sake, one sealing plate 13a of the sealing plates 13a, 13b might be also referred to as “first sealing plate” and the other sealing plate 13b might be also referred to as “second sealing plate”.

Regarding the outer case 10, in a state where the electrode assembly 20 is accommodated at an inside, the pair of opening parts 10a, 10b are covered by the sealing plates 13a, 13b. In this embodiment, for example, a positive electrode inside terminal 16 (see FIG. 3) is joined to a positive electrode tab 31c of the electrode assembly 20. In addition, a negative electrode inside terminal 17 (see FIG. 3) is joined to a negative electrode tab 41c of the electrode assembly 20. Further, a negative electrode outside terminal 15 is joined to the negative electrode inside terminal 17, and the sealing plate 13b is attached to the negative electrode tab 41c of the electrode assembly 20. In this state, the positive electrode tab 31c side at which the positive electrode inside terminal 16 is attached is put into the opening part 10b of the body 11, so that the electrode assembly 20 is inserted into the body 11. Then, the positive electrode outside terminal 14 attached to the sealing plate 13a is joined to the positive electrode inside terminal 16 configured to project from the other opening part 10a of the body 11. By doing this, it becomes in a state where the sealing plate 13a is attached to the positive electrode tab 31c of the electrode assembly 20 inserted into the body 11 and the sealing plate 13b is attached to the negative electrode tab 41c. After that, peripheral edge parts of the sealing plates 13a, 13b are respectively welded to peripheral edge parts of the opening parts 10a, 10b. By doing this, the pair of opening parts 10a, 10b of the body 11 is hermetically sealed by the sealing plates 13a, 13b.

Incidentally, in forms shown by FIG. 1 to FIG. 3, the outer case 10 is illustrated to which the sealing plates 13a, 13b is attached at both sides of the body 11 whose both ends are opened and which is formed in a square tube shape. In other words, here, a so-called both terminal type electricity storage device is illustrated in which the positive electrode outside terminal 14 and the negative electrode outside terminal 15 are attached to both sides of the sealing plates 13a, 13b. However, the electricity storage device is not restricted to the form described above. The form of the electricity storage device might be, for example, configured with a box-shaped body having a bottomed rectangular parallelepiped shape whose one side surface (an upper surface) is opened and with a sealing plate which seals the upper surface of this body. In other words, both of the positive electrode outside terminal and the negative electrode outside terminal might be attached to one sealing plate.

Based on perspectives of protecting the electrode assembly 20 from an impact and of considering a durability of the outer case 10, a material of the outer case 10 is suitably a metal material, such as aluminum, aluminum alloy, iron, and iron alloy.

Incidentally, the outer case 10 might be provided with a safe valve (not shown in drawings) and an injection port (not shown in drawings). The safe valve is a thin-walled valve that is set to release an internal pressure of the outer case 10 when the internal pressure is increased to be equal to or more than a predetermined level. The injection port is a port for injecting an electrolyte. The injection port becomes unnecessary after the electrolyte is injected, and thus can be sealed by laser welding. Alternatively, the injection port can be sealed by attaching a plug, or the like, too. Here, although not shown in drawings, the safe valve can be, for example, provided on a bottom surface 11b1, or the like. In addition, the injection port can be, for example, provided on any one of the first sealing plate 13a and the second sealing plate 13b.

The positive electrode outside terminal 14 and the negative electrode outside terminal 15, which are for outside connection, are provided in a state of being exposed to an outside of the outer case 10. These outside terminals are electrically connected to the electrode assembly 20 accommodated in the outer case 10. Further particularly, the positive electrode 30 of the electrode assembly 20 is electrically connected to the positive electrode outside terminal 14 that is exposed from the outer case 10. In addition, the negative electrode 40 of the electrode assembly 20 is electrically connected to the negative electrode outside terminal 15 that is exposed from the outer case 10. Regarding a suitable example of the electricity storage device of the present disclosure, as shown in FIG. 1 and FIG. 2, it is possible to make the outside terminal be exposed from both ends of the outer case 10. The positive electrode outside terminal 14 is provided on any one of surfaces of the pair of sealing plates 13a, 13b. In addition, the negative electrode outside terminal 15 is provided on the other sealing plate opposed to the sealing plate on which the positive electrode outside terminal 14 is provided. By doing this, even if the width of the side surface is narrow, it is possible to sufficiently secure a space for a current collector part, such as tab. In this embodiment, the positive electrode outside terminal 14 is provided on the first sealing plate 13a. In addition, the negative electrode outside terminal 15 is provided on the second sealing plate 13b. Incidentally, the positive electrode outside terminal 14 and the negative electrode outside terminal 15 are made of metal. As the positive electrode outside terminal 14, for example, it is possible to use an aluminum, an alloy in which the aluminum is a main, or the like. As the negative electrode outside terminal 15, for example, it is possible to use a copper, a copper alloy, or the like.

As shown in FIG. 3, the positive electrode outside terminal 14 can be electrically connected to the electrode assembly 20 via the positive electrode inside terminal 16. In addition, the negative electrode outside terminal 15 is electrically connected to the electrode assembly 20 via the negative electrode inside terminal 17. The positive electrode inside terminal 16 and the negative electrode inside terminal 17 are made of metal. As for the positive electrode inside terminal 16, from a perspective of enhancing a joint strength with the positive electrode tab 31c (or, the positive electrode active material layer non-formation part 31a), for example, it is possible to use aluminum, aluminum alloy, or the like. As the negative electrode inside terminal 17, from a perspective of enhancing a joint strength with the negative electrode tab 41c (or, the negative electrode active material layer non-formation part 41a), for example, it is possible to use copper, copper alloy, or the like.

In addition, the positive electrode outside terminal 14 and the negative electrode outside terminal 15 are attached, in a state of being insulated, to outer sides of the sealing plates 13a, 13b via a gasket (not shown in drawings). The positive electrode inside terminal 16 and the negative electrode inside terminal 17 are attached to inner sides of the sealing plates 13a, 13b via an insulator (not shown in drawings). As materials of the gasket and the insulator, for example, an insulation material can be used which is superior in a chemical resistance property and a weather resistance property.

### Electrolyte

The outer case 10 is configured to accommodate the electrolyte. For example, as the electrolyte, it is possible to use a liquid electrolyte (an electrolytic solution) which is in a liquid form at a room temperature (25° C.). As this electrolytic solution, it is possible to use a conventionally known nonaqueous electrolytic solution, without particular restriction. As for the nonaqueous electrolytic solution, carbonates are suitable. Incidentally, the electrolyte might be not only the above described nonaqueous electrolytic solution, but also a solid electrolyte in which all of the electrolyte is solid.

Anyway, the sealed type electricity storage device as described above tends to cause an expansion and contraction in response to the electrical charge and discharge, to have the inside swelling over time, and to have the outer case 10 swelling. In a situation where the sealed type electricity storage device becomes larger and an energy density is high, or the like, the outer case 10 further often tends to swell. The present inventor wants to suppress the swell of the electricity storage device. Based on a knowledge of the present inventor, regarding the polygonal electricity storage device, the swelling tends to deform the outer case 10 or to apply a load on a corner part of the outer case.

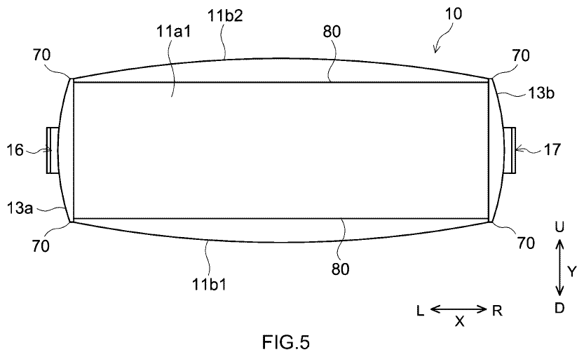

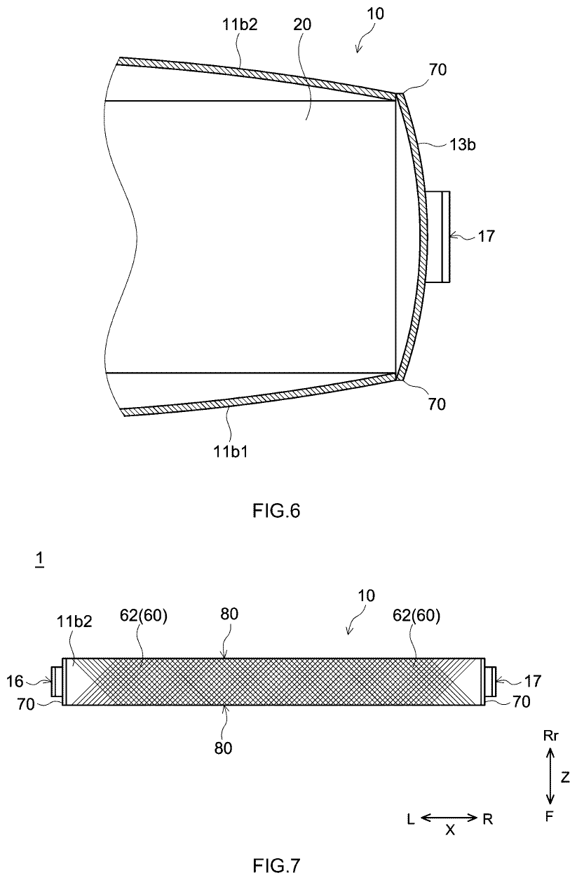

FIG. 5 is a schematic view that is for explaining a state after the swell of the electricity storage device. FIG. 6 is an enlarged cross section view that is shown to explain the state after the swell of the electricity storage device. FIG. 6 shows an enlarged cross section view of a corner part 70 that is formed by respective short sides of narrow width surfaces 11b1, 11b2 and sealing plates 13a, 13b shown in FIG. 5.

The electricity storage device is gradually swelling when the electrical charge and discharge is repeated. A cause of swelling of the electricity storage device described above is considered, for example, to be an expansion of the accommodated electrode assembly, a gas generation inside the outer case, or the like. Among them, in the situation where the gas is generated at the inside of the outer case, the internal pressure is increased. By doing this, as shown in FIG. 5, a side surface of the outer case 10 expands largely. In other words, force is applied to the side surface from the inside of the outer case 10, and thus it is under a state where the load tends to be easily applied onto the corner part because of this stress. As shown in FIG. 6, the outer case 10 is swelling according to the increase in the internal pressure. Then, by the pair of opposed narrow width surfaces 11b1, 11b2 and the second sealing plate 13b, which have been pushed from the inside of the outer case 10, the corner part 70 is pulled to both sides. By doing this, the load is applied onto the corner part 70.

Incidentally, from a perspective of enhancing the volume energy efficiency, it is preferable that the electricity storage device includes the polygonal outer case 10. As described above, the polygonal electricity storage device is formed in a hexahedron (in other words, consisting of 6 surfaces) shape. Since the pressure applied to each surface of the polygonal outer case 10 is uneven, the surface (especially, a vicinity of a center of the surface) swells more largely as an area size of the surface is larger. Thus, regarding the polygonal outer case 10, a surface tends to more easily suffer an effect of the increase in the internal pressure of the electricity storage device and to more easily be deformed, as an area size of the surface is larger. By doing this, the stress tends to be concentrated more easily on the corner part 70 formed by the short sides (in this embodiment, an joint part of the body 11 and the sealing plates 13a, 13b), and then the load is applied.

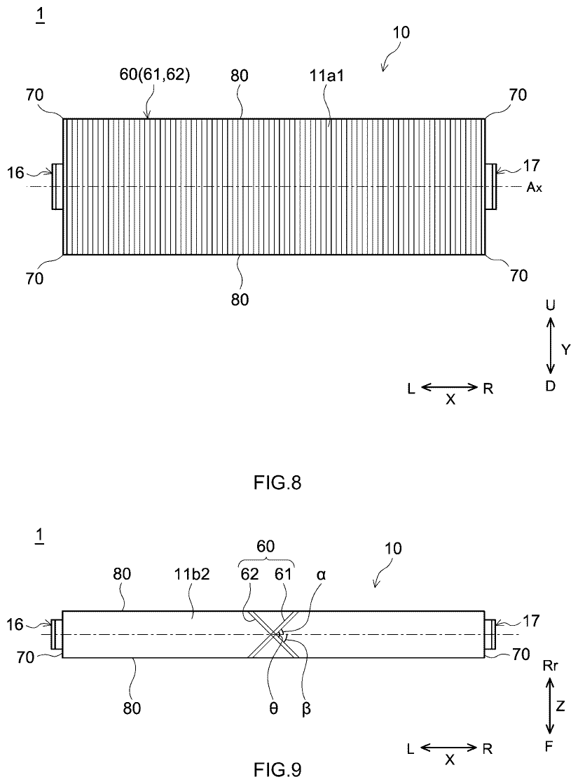

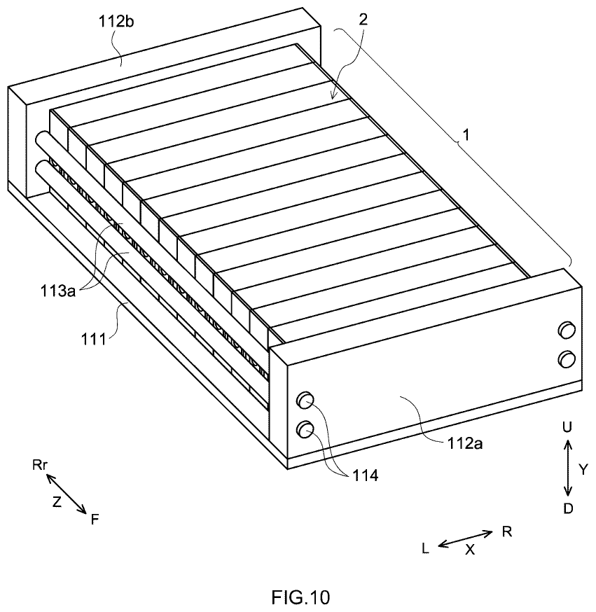

The present inventor proposes a new configuration, regarding the electricity storage device, based on the knowledge described above. FIG. 7 is a schematic plane view in which the lithium ion secondary battery 1 is viewed from a narrow width surface 11b2 side. FIG. 8 is a schematic plane view in which the lithium ion secondary battery 1 is viewed from a wide width surface 11a1 side. FIG. 9 is an explanation view that is to illustrate how to wind the fiber 60 of the lithium ion secondary battery 1. Incidentally, FIG. 9 simplifies and shows FIG. 6, in order to explain how to wind the fiber 60. A structure of the electricity storage device proposed herein is used in the lithium ion secondary battery 1 of FIG. 7 to FIG. 9.

### Fiber 60

As shown by FIG. 7, in this embodiment, the fiber 60 is wound on the pair of opposed narrow width surfaces 11b1, 11b2. In addition, as shown by FIG. 8, the fiber 60 is wound on the pair of opposed wide width surfaces 11a1, 11a2, too. In other words, the fiber 60 is continuously wound on the pair of opposed wide width surfaces 11a1, 11a2 and the pair of opposed narrow width surfaces 11b1, 11b2 via a corner part 80 formed by the long sides.

The fiber 60 includes a first fiber 61 wound on the narrow width surfaces 11b1, 11b2 along a first direction, and a second fiber 62 wound on the narrow width surfaces 11b1, 11b2 along a second direction. The second direction is facing in a direction different from the first direction. In particular, as shown by FIG. 7, the first fiber 61 and the second fiber 62 are wound on the outer case 10 so as to cross to each other.

When a side surface, on which the fiber 60 is wound, is viewed in a plane view, a angle a at which the first fiber 61 is wound on the outer case 10 is preferably 10°to 80° (further preferably 20° to 70°, or furthermore preferably 30° to 60°). Below, the term “angle” used for the fiber in the present description means an angle defined by a line dividing the side surface (here, the upper surface 11b2) of the outer case 10 into two along a central axis AX and a direction of the fiber 60 wound on the outer case 10 as shown in FIG. 9. In addition, the angle a is an angle at which the first fiber 61 is wound with respect to the line dividing the side surface (here, the upper surface 11b2) of the outer case 10 into two along the central axis AX. Incidentally, the term “central axis” used for the outer case in the present description is a line passing the centers of the respective surfaces of the pair of opposed side surfaces. In this embodiment, the central axis AX is drawn to pass a center of a surface whose area size is the smallest. Further particularly, it is a line passing the center of the side surface (the first sealing plate 13a) on which the outside terminal (in particular, the positive electrode outside terminal 14 and/or the negative electrode outside terminal 15) is provided and the center of the surface (the second sealing plate 13b) opposed to said side surface. In addition, an angle β is an angle at which the second fiber 62 is wound with respect to the line dividing the side surface (here, the upper surface 11b2) of the outer case into two along the central axis AX. The angle β at which the second fiber 62 is wound on the outer case 10 is preferably −80° to −10° (further preferably −70° to −20°, or furthermore preferably −60° to −30°).

In addition, as shown in FIG. 9, the angle defined by the first direction and the second direction is θ. The θ is not particularly restricted. From a perspective of making easier to suppress the swell of the side surface of the outer case 10, an upper limit value of the angle θ defined by the first direction and the second direction might be equal to or less than 160°, is preferably equal to or less than 140°, is further preferably equal to or less than 120°, or is furthermore preferably equal to or less than 90°. In addition, a lower limit value of the θ is preferably equal to or more than 20°, further preferably equal to or more than 40°, or furthermore preferably equal to or more than 60°.

A thickness of the fiber 60 (for example, a diameter) is not restricted particularly, insofar as an effect of the technique of the present disclosure is not significantly spoiled. In addition, the fiber 60 can configure a layer on which the first fiber 61 and the second fiber 62 are stacked. In this embodiment, the second fiber 62 is wound on the first fiber 61 (more outer side from the body 11) that is wound on the body 11. The layer of the fiber 60 has a thickness. The thickness of the layer (in other words, the thickness when the fiber 60 is wound on the body 11) is not restricted, particularly. From a perspective of enhancing an impact resistance property, the thickness of the layer is preferably equal to or more than 10%, further preferably equal to or more than 15%, or furthermore preferably equal to or more than 20%, with respect to the thickness of the body 11 (the plate thickness). In addition, an upper limit value of the thickness of the layer might be equal to or less than 30%, might be equal to or less than 25%, or might be equal to or less than 22%, with respect to the thickness of the body 11 (the plate thickness). A thickness of the first fiber 61 and a thickness of the second fiber 62 might be the same, or might be different from each other. Incidentally, an order for winding the first fiber 61 and the second fiber 62 is not restricted, particularly. The first fiber 61 might be wound on the second fiber 62. In addition, the additional first fiber 61 might be overlappingly wound on the first fiber 61, or the additional second fiber 62 might be overlappingly wound on the second fiber 62. After the first fiber 61 and the second fiber 62 are wound, the additional first fiber 61 and the additional second fiber 62 might be wound in an arbitrary order.

A interval of the fiber 60 wound on the same direction (the first fiber 61 or the second fiber 62) is not restricted particularly, insofar as an effect of the technique of the present disclosure is not significantly spoiled. In addition, the interval of winding the fiber 60 might be the same or different on the first fiber 61 and on the second fiber 62.

As the fiber 60 being suitable, for example, it is possible to use a glass fiber, a carbon fiber, an aramid fiber, or the like. These fibers have high tensile strengths, and thus it is possible to enhance the strengths of points covered by these fibers. Among these fibers, the glass fiber has an advantage of being superior in a heat insulation property. The carbon fiber has advantages of being superior in a machinability and of being processed easily. In addition, the aramid fiber has an advantage of being superior in the insulating property. As a material of the fiber 60, it is possible to be suitably decided according to an object.

The fiber 60 contains the resin as a base material. As the resin being suitable, for example, it is possible to use a thermosetting resin, or a thermoplastic resin. As the thermosetting resin, for example, it is possible to use an epoxy resin, an unsaturated polyester resin, a vinyl ester resin, a phenolic resin, a polyurethane resin, a silicon resin, or the like. In addition, as the thermoplastic resin, it is possible to use a polyolefin resin, a polyvinyl chloride resin, a polystyrene resin, a fluorine resin, or the like.

Incidentally, a suitable manufacturing method of the outer case 10, for example, can include a step for winding the resin-impregnated fiber 60 onto the outer case 10 and a step for hardening the resin.

At the step for winding the resin-impregnated fiber 60 onto the outer case 10, the outer case 10 formed in a square tube shape before the opening part 10b is sealed is prepared. A mandrel (a core metal) fixing this outer case 10 is rotated, so as to wind the fiber 60 on the side surface of the outer case 10 (here, the pair of opposed wide width surfaces 11a1, 11a2 and the pair of opposed narrow width surfaces 11b1, 11b2). At that time, the fiber 60 is wound on the outer case 10 while the mandrel and/or a reel is moved in the central axis AX direction, so that it is possible to wind at the angle. Incidentally, for arranging the wide width surfaces 11al, 11a2 of the lithium ion secondary battery 1 in an opposed manner regarding the later described electricity storage module 100, as shown by FIG. 5, in this embodiment, the fiber 60 is wound on the pair of opposed wide width surfaces 11a1, 11a2 to be orthogonal to the central axis AX (see FIG. 8).

At the step for hardening the resin, for example, when a thermosetting resin is used as the base material, it is possible to fix the fiber 60 by using a heater, or the like, and thus by baking and hardening it. According to the manufacturing method as described above, a fiber reinforced layer in which the side surface of the electricity storage device is continuously covered by the fiber 60 is formed, and thus it is possible to enhance a resistance property for the increase in the internal pressure. Incidentally, the above described manufacturing method is not to restrict the manufacturing method of the electricity storage device of the present disclosure. As another manufacturing method, it is also possible to use a sheet winding method so as to manufacture the outer case 10 covered by the fiber 60.

As described above, the outer case 10 of the herein disclosed electricity storage device is covered by the fiber reinforced resin layer. Thus, it is possible to enhance a strength of the outer case 10. In addition, regarding the outer case 10, by winding the fiber 60, the swell of the outer case 10 is suppressed. By doing this, it is possible to suppress a deformation of the outer case 10.

In the above described embodiment, on the outer case 10, the fiber 60 continuing to cover an outer periphery side surface is wound to be arranged along a predetermined direction. According to the fiber 60 described above, it is possible to suppress the expansion of the side surface of the outer case 10. As a result, it is possible to inhibit a stress applied to the corner part 70 of the outer case 10.

In the above described embodiment, the electricity storage device includes the electrode assembly 20 and the outer case 10. The outer case 10 is the polygonal case that includes the pair of opposed wide width surfaces 11a1, 11a2 and the pair of opposed continuous narrow width surfaces 11b1, 11b. In addition, the electrode assembly 20 has a laminate structure in which the strip-like shaped positive electrode 30 and the strip-like shaped negative electrode 40 are stacked via the separator 50 along the pair of opposed wide width surfaces 11a1, 11a2 of the polygonal case. According to the configuration described above, the flat surface 21 of the electrode assembly 20 and the wide width surface (the first surface 11a1 or the second surface 11a2) of the outer case 10 are opposed to each other. By doing this, even in a situation where the wide width surfaces 11a1, 11a2 are pressed in accordance with the expansion of the electrode assembly 20, it is possible to prevent the outer case 10 from swelling. As a result, it is possible to suppress the load applied onto the corner part 80.

In the above described embodiment, on the side surface of the outer case 10, the first fiber 61 is wound in a direction which implements the angle α. In addition, the second fiber 62 is wound in a direction which implements the angle β. By doing this, on the pair of opposed narrow width surfaces 11b1, 11b2 of the outer case 10, the first fiber 61 and the second fiber 62 are wound in a state of being crossed. By doing that, it is possible to restrict the side surface (the wide width surfaces 11a1, 11a2 and the narrow width surfaces 11b1, 11b2) of the outer case 10, and to suitably prevent the swell caused by the increase in the internal pressure of the outer case 10. Additionally, in this embodiment, the narrow width surface (here, the upper surface 11b2) is welded and joined at the step for manufacturing the body 11 formed in a square tube shape. Because the first fiber 61 and the second fiber 62 cover the upper surface 11b2 of the outer case 10 as to be crossed, it is possible to suitably protect the welded and joined part 10c. As a result, it is possible to enhance the strength of the outer case 10.

### Electricity Storage Module

The electricity storage module includes the electricity storage device of the present disclosure and a restriction member that is configured to allow the electricity storage devices being arranged in a predetermined direction and to restrict the electricity storage devices.

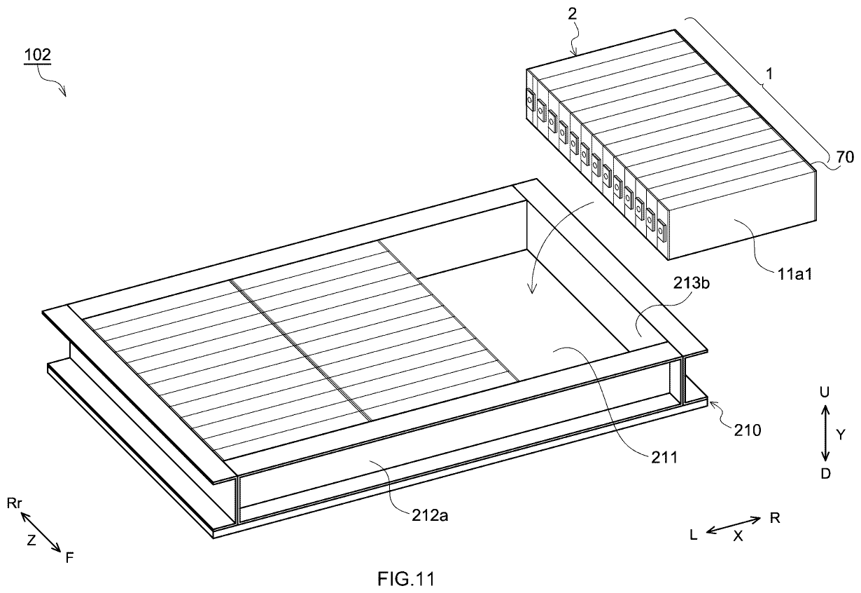

As a suitable one example of the electricity storage device in the present disclosure, it is possible to use an electricity storage module 100 as shown in FIG. 9. FIG. 10 is a perspective view that schematically shows the electricity storage module containing the electricity storage device in accordance with another embodiment disclosed herein. This electricity storage module 100 includes plural electricity storage devices (for example, the lithium ion secondary batteries 1) and the restriction member 110.

As shown by FIG. 10, in this example, the wide width surfaces 11a1, 11a2 of the lithium ion secondary battery 1 and the wide width surfaces 11a1, 11a2 of the adjacent lithium ion secondary battery 1 are opposed to each other and are arranged in a front and back direction Z so as to form a laminate body 2. In addition, the positive electrode outside terminal 14 and the negative electrode outside terminal 15 provided on the pair of sealing plates 13a, 13b are arranged respectively in different directions to be arranged alternately. Here, the positive electrode outside terminal 14 of one lithium ion secondary battery 1 and the negative electrode outside terminal 15 of the other lithium ion secondary battery 1, which are adjacent, can be electrically connected in a mutual manner by a metal bus bar (not shown in drawings). However, a configuration of this embodiment is not to restrict arrangement and connecting method of the lithium ion secondary batteries 1. The lithium ion secondary batteries 1 can be connected in series or in parallel.

In addition, the herein disclosed electricity storage module might include plural spacers. As shown in FIG. 9, the electricity storage module 100 includes the plural spacers 120. The spacer 120 is arranged between the wide width surfaces 11a1, 11a2 of the lithium ion secondary battery 1 and the wide width surfaces 11a1, 11a2 of the opposed lithium ion secondary battery 1. The spacer 120 is to have a function of suppressing the swell by adding a load onto the side surface of the lithium ion secondary battery 1. In addition, the spacer 120 has a function as a buffer material that is configured to protect the lithium ion secondary battery 1 from an impact or a vibration coming from an outside, too. Incidentally, as the spacer 120, it is possible to use a conventionally known one. A material of the spacer 120 is not restricted, particularly. As the material of the spacer 120, it is preferable to use rubbers (thermosetting elastomers).

### Restriction Member

As a suitable example of the restriction member configuring the herein disclosed electricity storage module, for example, it is possible to use one shown in FIG. 9. In this example, the restriction member 110 includes a pair of opposed end plates 112, a pair of side bars 113, and a bottom plate 111. The pair of end plates 112 include a first end plate 112a arranged at a side of one end part (here, an end part at a front F side) of arranged plural lithium ion secondary batteries 1, and include a second end plate 112b arranged at a side of the other end part (an end part at a rear Rr side). The pair of side bars 113 are configured to connect the first end plate 112a and the second end plate 112b opposed to this first end plate 112a. In this example, to support the pair of sealing plates 13a, 13b that become the side surface of the lithium ion secondary battery 1, two first side bars 113a and two second side bars 113b are configured to bridge. In addition, the bottom plate 111 is arranged to abut on the bottom surfaces 11b1 of the plural lithium ion secondary batteries 1. The upper surfaces 11b2 of the plural lithium ion secondary batteries 1 are in a state of being not supported by the restriction member 110.

In the above described electricity storage module, the pair of opposed wide width surfaces 11a1, 11a2 of the lithium ion secondary battery 1 are restricted. In other words, the load is applied in a laminate direction (here, the front and back direction Z) of the lithium ion secondary battery 1, the swell of the pair of opposed wide width surfaces 11a1, 11a2 is suppressed. Thus, regarding the electricity storage device (in other words, the electricity storage module) restricted as described above, the pressure is concentrated by the pair of opposed narrow width surfaces 11b1, 11b2, and thus it tends to cause the swell more easily. On the other hand, regarding the lithium ion secondary battery 1, the pair of opposed narrow width surfaces 11b1, 11b2 are covered by the fiber 60. By doing this, the swell of the outer case 10 is suppressed, and therefore it is possible to reduce the load applied onto the corner part 70.

In addition, as another suitable example of the herein disclosed electricity storage module, it is possible to use a pack type one as shown by FIG. 11. FIG. 11 is a perspective view that schematically shows a herein disclosed pack-case type electricity storage module 102. In FIG. 11, for clearly showing a configuration of the pack-case type electricity storage module 102, it is partially decomposed and then shown. The pack-case type electricity storage module 102 has a Cell-to-Pack structure in which the plural lithium ion secondary batteries 1 are accommodated at the inside of the restriction member 110 (in this example, a pack case 210).

The pack case 210 used for the herein disclosed pack-case type electricity storage module 102 includes a bottom wall 211, a side wall 212, and an upper wall (not shown in drawings). As shown in FIG. 11, the side wall 212 extending along the left and right direction X directly supports both ends of the laminate body 2. On the bottom wall 212, plural lithium ion secondary batteries 1 are arranged. The lithium ion secondary battery 1 and the bottom wall 211 are adhered by an adhesion agent, or the like. By doing this, the lithium ion secondary battery 1 is fixed at the inside of the pack case 210. The upper wall is configured to form an upper part of the pack case 210. The upper wall is opposed to the bottom wall 211. The upper wall is arranged to cover the plural lithium ion secondary batteries 1 accommodated at the inside of the pack case 210.

In this Cell-to-Pack structure, the side wall 212 of the pack case 210 directly supports the both ends of the laminate body 2 of the lithium ion secondary battery 1. According to the configuration described above, it is possible to reduce the restriction member, and thus it is possible to enhance a volume energy efficiency as a module.

In the above described Cell-to-Pack structure, the pair of opposed wide width surfaces 11a1, 11a2 of the lithium ion secondary battery 1 are restricted. Thus, the swell of the wide width surfaces 11a1, 11a2 being restriction surfaces is suppressed. However, the pressure is concentrated by the pair of opposed narrow width surfaces 11b1, 11b2 being not restricted, and thus it tends to cause the swell more easily. In addition, different from the above described electricity storage module 102, the number of the restriction members 110 is little, and thus it is preferable to enhance the strength of the electricity storage device and to protect from the impact or the vibration. Here, the lithium ion secondary battery 1 is covered by the fiber 60. By doing this, the swell of the outer case 10 is suppressed, and thus it is possible to reduce the load applied onto the corner part 70. In addition, it enhances the strength of the outer case 10, and therefore it has become to have a high resistance against the impact and the vibration.

In the technology disclosed herein, each component or each process referred to herein may be omitted or combined as appropriate, to the extent that no particular problems arise. This specification also includes the disclosures set forth in the following respective items.
Item 1: An electricity storage device, comprising: an electrode assembly that comprises a positive electrode and a negative electrode; and an outer case that is made of a metal and that accommodates the electrode assembly, wherein on the outer case, a continuous fiber is wound to cover an outer periphery side surface, the fiber being to be aligned along a predetermined direction.
Item 2: The electricity storage device according to item 1, wherein the outer case is a polygonal case that comprises a pair of opposed wide width surfaces and a pair of opposed narrow width surfaces continuing to the wide width surfaces, the electrode assembly comprises a laminate structure in which a strip-like shaped positive electrode and a strip-like shaped negative electrode are stacked via a separator along the pair of opposed wide width surface of the polygonal case, and the fiber is wound continuously on the pair of opposed wide width surfaces and the pair of opposed narrow width surfaces.
Item 3: An electricity storage module, comprising: the electricity storage device according to item 1 or 2; and a restriction member that is configured to allow the electricity storage devices being arranged in a predetermined direction and to restrict the electricity storage devices.

What is claimed is

1. An electricity storage device, comprising:
an electrode assembly that comprises a positive electrode and a negative electrode; and
an outer case that is made of a metal and that accommodates the electrode assembly, wherein
on the outer case, a continuous fiber is wound to cover an outer periphery side surface, the fiber being to be aligned along a predetermined direction.

2. The electricity storage device according to claim 1, wherein
the outer case is a polygonal case that comprises a pair of opposed wide width surfaces and a pair of opposed narrow width surfaces continuing to the wide width surfaces,
the electrode assembly comprises a laminate structure in which a strip-like shaped positive electrode and a strip-like shaped negative electrode are stacked via a separator along the pair of opposed wide width surface of the polygonal case, and
the fiber is wound continuously on the pair of opposed wide width surfaces and the pair of opposed narrow width surfaces.

3. An electricity storage module, comprising:
the electricity storage device according to claim 1; and
a restriction member that is configured to allow the electricity storage devices being arranged in a predetermined direction and to restrict the electricity storage devices.
